(19) United States
(12) Patent Application Publication
(10) Pub. No.: US 2013/0304567 A1
(43) Pub. Date: Nov. 14, 2013

(54) METHODS AND APPARTUS TO ASSESS MARKETING CONCEPTS PRIOR TO MARKET PARTICIPATION

(71) Applicants: Christopher Adrien, Cincinnati, OH (US); Daivd A. Duncan, Milford, OH (US); Neal L. Hubert, Cincinnati, OH (US)

(72) Inventors: Christopher Adrien, Cincinnati, OH (US); Daivd A. Duncan, Milford, OH (US); Neal L. Hubert, Cincinnati, OH (US)

(21) Appl. No.: 13/670,805

(22) Filed: Nov. 7, 2012

Related U.S. Application Data
(60) Provisional application No. 61/645,908, filed on May 11, 2012.

(51) Int. Cl. G06Q 30/02

(52) U.S. Cl. CPC G06Q 30/0243
USPC 705/14.42

(57) ABSTRACT

Methods and apparatus are disclosed to assess marketing concepts prior to market participation. An example method includes determining a value for an explanatory variable (EV) associated with a new commercial offering, identifying a plurality of existing commercial offerings based on a similarity metric associated with the new commercial offering, identifying a rank of the new commercial offering based on a comparison between the EV value associated with the new commercial offering and EV values associated with the plurality of existing commercial offerings, and generating the probability of success for the new commercial offering based on the rank of the new commercial offering and in-market performance metrics associated with the plurality of existing commercial offerings.

### FIELD OF THE DISCLOSURE

This disclosure relates generally to market research, and, more particularly, to methods and apparatus to assess marketing concepts prior to market participation.

### BACKGROUND

For many years, manufacturers have sought techniques to prepare new products for a market in a manner that improves success once such products actually launch in the marketplace. Factors that may contribute to a degree of success or failure of a product and/or service include packaging, communication of features and/or novelty of the product in the market. In the event the factors associated with a product result in poor sales, then one or more subsequent attempts to re-tool the product with one or more alternate set of factors may not be successful. Such example scenarios increase an urgency on behalf of the manufacturer to identify a satisfactory set of factors for the product prior to market release.

### BRIEF DESCRIPTION OF THE DRAWINGS

FIG. 1 is a schematic illustration of a system to assess marketing concepts prior to market participation.

FIG. 2 is a chart of example explanatory variable correlations generated by the example system of FIG. 1.

FIG. 3 is a chart of example explanatory variable thresholds generated by the example system of FIG. 1.

FIG. 4 is an example product delivery explanatory variable model associated with a candidate commercial offering.

FIGS. 5-9 are flowcharts representative of example machine readable instructions which may be executed to assess marketing concepts prior to market participation.

FIG. 10 is a schematic illustration of an example processor platform that may execute the instructions of FIGS. 5-9 to implement the example systems and apparatus of FIGS. 1-4.

### DETAILED DESCRIPTION

Marketers, analysts, product manufacturers and/or other entities chartered with a responsibility to bring products (e.g., marketing concepts, new products, previously existing products having one or more altered concepts/features, etc.) to the market (hereinafter referred to herein as analysts) strive to improve the odds of in-market success (e.g., a probability of product success in the market after marketplace introduction). Successful introduction of new products may be influenced by any number of factors deemed predictive of market success prior to release including, but not limited to distribution strategies, advertising strategies, and/or post-launch support strategies.

In the event an initial combination of factors associated with a product do not result in favorable short-term and/or long-term in-market performance, reworking the product with one or more subsequent combinations of factors and/or factor types may not result in improved market performance. In other words, some products may become permanently associated with a first impression that cannot be discarded and/or otherwise replaced with one or more improved factors.

Factors that help predict in-market success for a product (hereinafter referred to herein as “success factors”) may derive from one or more aspects of a consumer adoption process. A first example aspect of the consumer adoption process, sometimes referred to herein as dimensions, includes salience, communication, attraction, point-of-purchase and endurance. The example salience dimension refers to an indication of how a concept (e.g., one or more features associated with a commercial offering that is to be sold in a marketplace or has previously sold in the marketplace) of a commercial offering (e.g., a product/service) stands out from what is currently available in the market. The example communication dimension refers to an indication of how well a concept conveys a consumer proposition, and the example attraction dimension refers to an indication of how well a concept pulls-in consumers based on, for example, a message associated with the concept. For example, the attraction dimension may indicate a degree to which the concept meets a consumer need, desire and/or satisfies a void. The example point-of-purchase dimension refers to an indication of how a concept converts consumer attraction to a sale at the point-of-purchase, and the example endurance dimension refers to an indication of how a concept (e.g., a product) endures in the market over one or more periods of time (e.g., specific/particular periods of time).

Each of the example dimensions may include one or more factors that further specify details of the dimension. In the illustrated example, the salience dimension includes a distinct proposition factor to indicate how a concept stands out versus competitive products/services in a substantial way (e.g., a degree to which a concept deemed to be different than what exists in a current market environment). Additionally, the example distinct proposition factor of the illustrated example indicates a degree to which the concept provides a benefit-driven differentiation when compared to currently existing products. In example detail below, each dimension and/or corresponding factor(s) are scored by panelists and/or non-panelists (e.g., generally referred to herein as respondents) based on one or more survey questions, and may be combined to form an indication of success in the marketplace based on one or more outcomes obtained from consumers, and/or respondents (e.g., a success response variable). To elicit feedback and/or other measurements regarding the distinct proposition factor, a survey question may ask “If the product concept was not available, which statement best describes alternatives that are available for you to purchase?” In some examples, the respondent is presented with a discrete number of choices, such as “many alternatives,” “few alternatives,” “1-2 alternatives,” and “no alternatives.” Each of the example discrete choices may be weighted to reflect a corresponding score for the associated factor and/or dimension overall. In the event a respondent selected “many alternatives,” then, in the illustrated example, the score corresponding to the distinct proposition factor will be relatively low as compared to a selection of “no alternatives” because the strongest innovations typically include the fewest number of alternatives.

In the illustrated example, the salience dimension also includes an attention catching factor to indicate how well/poorly the concept stands out from an attention grabbing or executional point-of-view. To elicit feedback and/or other measurements regarding the attention catching factor, a survey question may ask “How would you rate the concept in terms of being new and different from other products currently available?” The respondent may be presented with a discrete number of choices, such as “extremely new and different,” “very new and different,” “somewhat new and different,” “slightly new and different,” and “not at all new and different.”

In some examples, the communication dimension includes both a message connection factor to indicate how strongly a concept conveys a key selling message, and a clear, concise message factor to indicate how clearly the concept conveys the key selling message. Each of the example message connection factor and/or the example clear, concise message factor may employ any number of survey questions to elicit respondent input on the strength of such factors and/or dimension(s).

In some examples, the attraction dimension includes both a need/desire factor to indicate a degree of relevance to consumer needs and/or wants related to a concept, and an advantage factor to indicate how well the concept meets the consumer needs in a way that other (existing) products fail to do. In some examples, the attraction dimension includes both a credibility factor to indicate a degree to which consumers have sufficient reason to believe that a corresponding product will deliver on its promises/assertions, and an acceptable downsides factor to indicate a degree to which a corresponding product is free of detractors (e.g., side effects) that could prevent consumers from converting their interest into attraction and/or a purchase. Each of the example need/desire, advantage, credibility and/or acceptable downsides factors may employ any number of survey questions to elicit respondent input on the strength of such factors and/or dimension(s).

In some examples, the point-of-purchase dimension includes a findability factor to indicate a degree related to how easily consumers can find a candidate product in stores where it is available. In some examples, the point-of-purchase dimension also includes an acceptable costs factor to indicate whether one or more cost/benefit trade-offs occur at the shelf, such as price, nutritional information, preparation and/or usage instructions associated with the candidate product. Each of the example findability and/or acceptable costs factors may employ any number of survey questions to elicit respondent input on the strength of such factors and/or dimension(s).

In some examples, the endurance dimension includes a product delivery factor to indicate a degree to which a candidate product performance exceeds expectations associated with the concept. The example endurance dimension of some examples also includes a product loyalty factor to indicate a degree to which the candidate product maintains a defense against competitive products over time. Each of the example product delivery and/or product loyalty factors may employ any number of survey questions to elicit respondent input on the strength of such factors and/or dimension(s).

While examples above disclose five dimensions and twelve corresponding factors, methods, systems, apparatus and/or articles of manufacture disclosed herein are not limited thereto. Any number (e.g., more, fewer, equal) of additional and/or alternate dimensions and/or factors indicative of market success may be employed, without limitation. Example methods, systems, apparatus and/or articles of manufacture disclosed herein determine dimension and/or factor scores for new concepts prior to market participation, cultivate subsequent market performance, and establish one or more dimension, factor and/or cumulative thresholds based on the market performance and one or more market success standards (e.g., success response variables). Additionally, example methods, systems, apparatus and/or articles of manufacture disclosed herein analyze new concepts prior to market participation to generate a probability of success based on previous and related product(s) and respondent scores related to the one or more dimensions and/or factors.

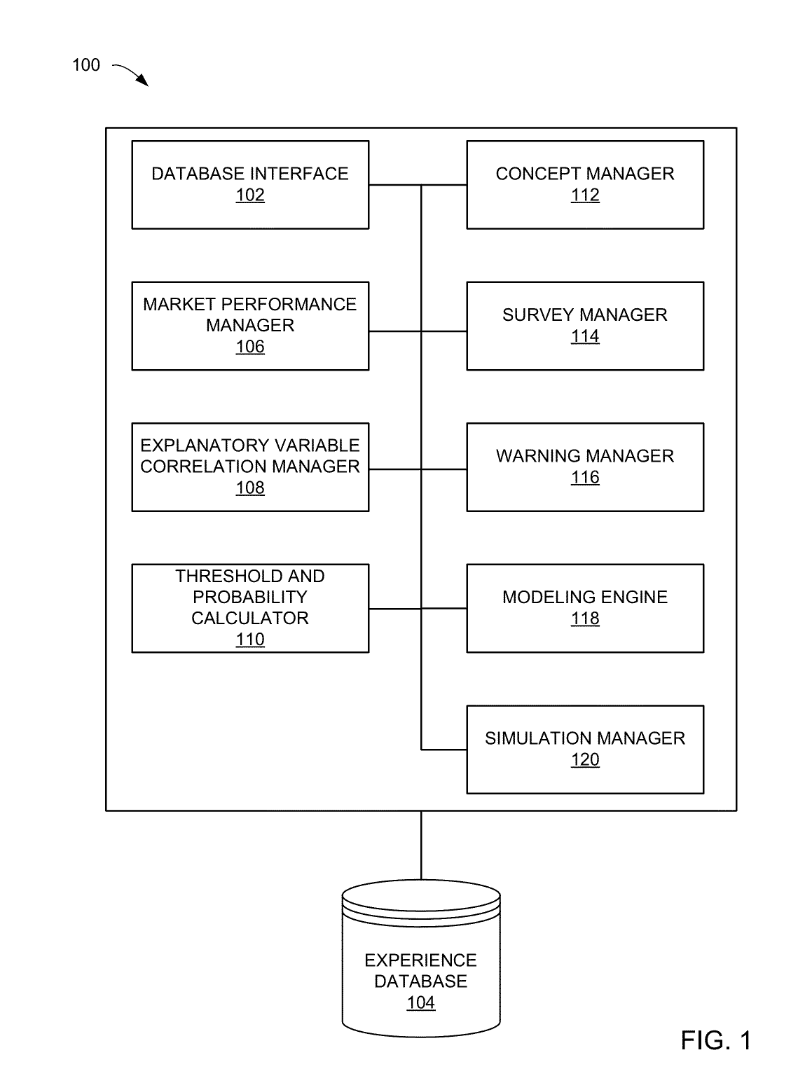

FIG. 1 is a schematic illustration of an example system 100 to assess marketing concepts (e.g., new products) prior to market participation. In the illustrated example of FIG. 1, the system 100 includes a database interface 102 communicatively connected to an experience database 104, a market performance manager 106, an explanatory variable correlation manager 108, a threshold and probability calculator 110, a concept manager 112, a survey manager 114, a market readiness manager 116, a modeling engine 118 and a simulation manager 120. In operation, the example database interface 102 selects a candidate product and/or category from the example experience database 104. The example experience database 104 of FIG. 1 includes information/data associated with products (e.g., client products, competitor products, etc.) that have been previously analyzed to reveal dimension and/or factor scores for product(s) prior to its release to a market. In some examples, outcomes are revealed by comparing test products to one or more previous experiences to yield one or more performance indicators. Additionally, one or more additional/alternate databases of FIG. 1 may include data/information related to launch datasets associated with model building. Such launch datasets may include information related to market performance, and/or indications of what a client deems a success or failure in the market.

The example market performance manager 106 of FIG. 1 selects one or more explanatory variables and corresponding market performance data associated with a product of interest from the example experience database 104. As used herein, dimensions and factors are discussed interchangeably with explanatory variables, which represent one or more aspects of a product or a product's concept that is believed to have an impact on market performance. While five example dimensions and twelve corresponding factors (explanatory variables) were discussed above, any number of additional and/or alternative dimensions and/or factors may be used with example methods, apparatus, systems and/or articles of manufacture disclosed herein. To identify whether one or more explanatory variables have one or more relationships to one or more other explanatory variables, the example explanatory variable correlation manager 108 applies frequency and correlation analysis to the one or more explanatory variables selected by the example market performance manager 106. Generally speaking, model performance may be improved when issues related to potential multi-collinearity are resolved before model evaluation occurs, such as model evaluation to generate a probability of success for a concept and/or corresponding product prior to market participation. Model performance may be thwarted by erratic changes in coefficient estimates when two or more predictor variables (e.g., explanatory variables, such as two or more of the above-identified factors) are relatively highly correlated. Identifying one or more instances of multi-colinearity between EVs facilitates stabilization of one or more models when generating one or more probability values.

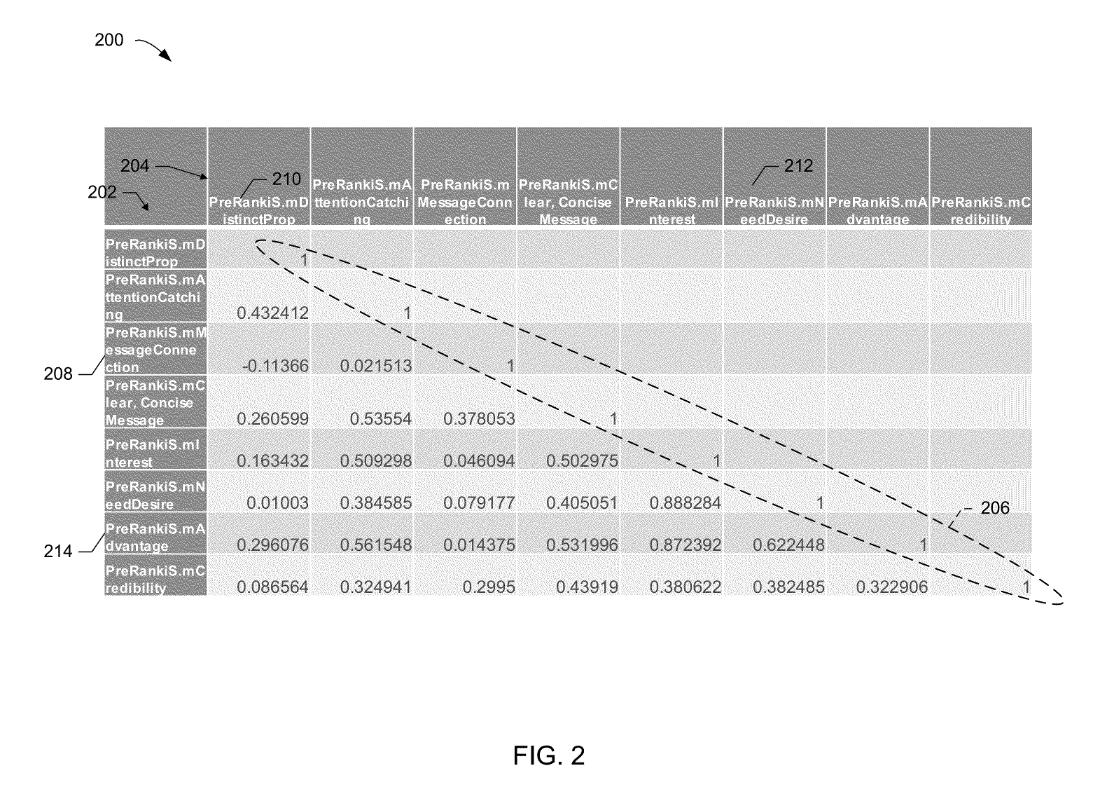

FIG. 2 illustrates an example explanatory variable correlation chart 200 having a column of explanatory variables 202 and a corresponding row of the same explanatory variables 204. In the illustrated example of FIG. 2, the chart 200 illustrates an indication of correlation between the one or more explanatory variables selected by the example market performance manager 106. While, in the example of FIG. 2, a diagonal matrix 206 identifies a relationship between identical explanatory variables (value=“1”), non-identical explanatory variables are processed by the example explanatory variable correlation manager 108 to establish a corresponding correlation variable. Some example pairs of explanatory variables have a relatively weak or negative correlation, such as the value −0.11366 between Message Connection 208 and Distinct Proposition 210. On the other hand, some example pairs of explanatory variables have a relatively strong correlation, such as the value 0.622448 between Need/Desire 212 and Advantage 214. While information from one or more surveys is combined into each explanatory variable, some correlations may suggest that one or more explanatory variables are independent in nature. In other words, example methods, apparatus, systems and/or articles of manufacture disclosed herein reveal that some explanatory variables may have a degree of independent importance to overall success of a product (e.g., a new product).

Returning to the illustrated example of FIG. 1, the example market performance manager 106 selects one of the explanatory variables, and employs the threshold and probability calculator 110 to establish a threshold variable. The example threshold variable calculated by the example threshold and probability calculator 110 is based on an aggregated score for the explanatory variable and a degree of market performance success for the corresponding product. For example, in the event a product includes a particularly high score for a first explanatory variable, and a subsequent market performance illustrates an empirical metric of success, then the example threshold and probability calculator 110 identifies a threshold value for the first explanatory variable. In the event one or more alternate and/or additional similar products include a similar score (e.g., a similarity metric) for the first explanatory variable, then the established threshold value may be weighted by the example threshold and probability calculator 110 to a relatively higher degree to confirm empirical support that the threshold is a valid indication of success for that combination of product and explanatory variable. In some examples, such iterative and/or periodic analysis of success operates to cultivate a learning tool for one or more products and/or candidate products.

Indications of success may be tailored in a manner acceptable to each analyst (e.g., manufacturer, client, etc.) that employs example methods, apparatus, systems and/or articles of manufacture disclosed herein. Indications of success may be categorized with relatively high level labels and/or colors based on one or more ranges of values, thereby providing a quick indication to analysts of concept readiness without excessive detail. In some examples, an “outstanding” label may be associated with commercial offerings that provide a relatively significant (e.g., related to a threshold) advantage over other similarly-categorized products/services. In other examples, a threshold probability value separates the outstanding label from one or more less advantageous labels. In still other examples, a “ready” label may be associated with commercial offerings that meet one or more success criteria (e.g., meet a short term volumetric objective, meet a 2-year market share objective, etc.). The ready label may be associated with a particular probability of success value, such as a probability greater than 0.67. In some examples, a “risky” label may be associated with commercial offerings that approach one or more success criteria metrics, but have not yet reached such thresholds. In still further examples, a “failure” label may be associated with commercial offerings that demonstrate a barrier to market success. The failure label may be associated with a particular probability of success value, such as a probability value less than 0.33.

The example threshold and probability calculator 110 of FIG. 1 may process each available explanatory variable in the example experience database 104 to determine a corresponding threshold value in view of a product and/or product type. For example, the findability explanatory variable may be more frequently observed for niche products, but less frequently observed for mass market products (e.g., diapers). In other words, diaper products are typically established in retail establishments in a known general location, thereby making the findability explanatory variable less frequently observed as a failure.

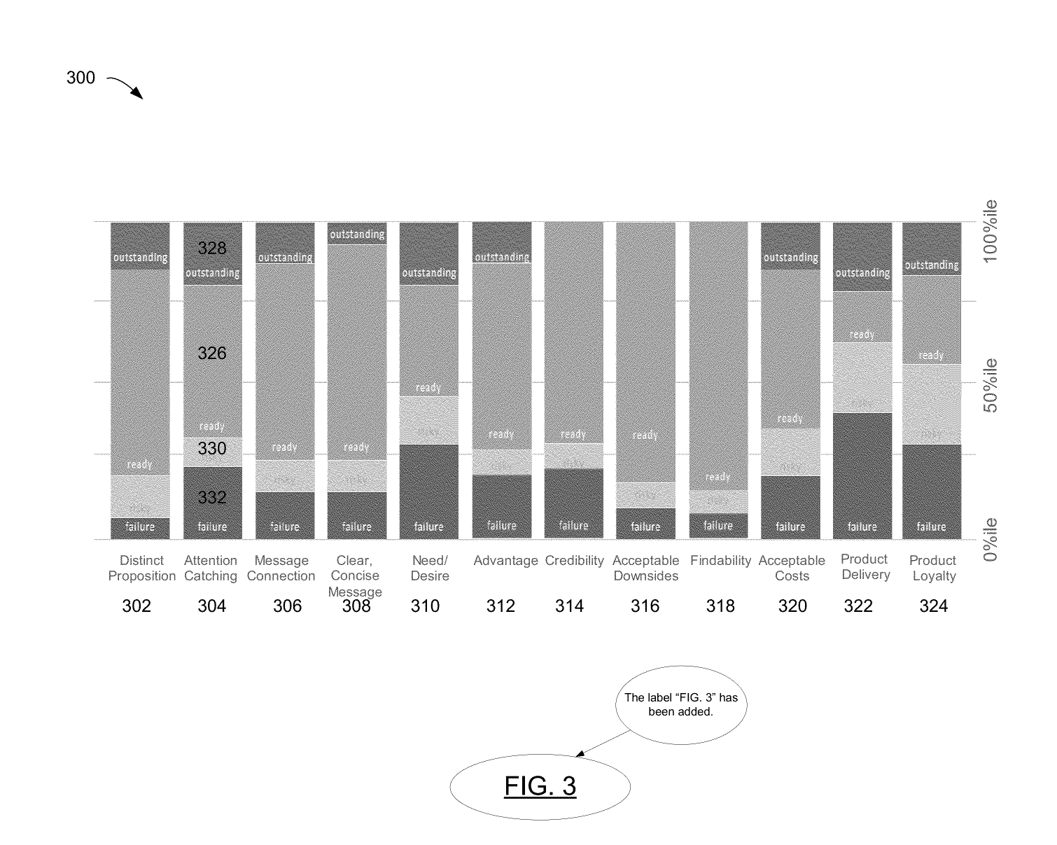

FIG. 3 illustrates an example explanatory variable (EV) threshold chart 300 for a candidate product of interest. In the illustrated example of FIG. 3, the chart 300 includes a distinct proposition EV threshold indicator 302, an attention catching EV threshold indicator 304, a message connection EV threshold indicator 306, a clear, concise message EV threshold indicator 308, a need/desire EV threshold indicator 310, an advantage EV threshold indicator 312, a credibility EV threshold indicator 314, an acceptable downsides EV threshold indicator 316, a findability EV threshold indicator 318, an acceptable costs EV threshold indicator 320, a product delivery EV threshold indicator 322 and a product loyalty EV threshold indicator 324. Each example EV threshold indicator (302-324) may include a failure threshold zone, a risky zone, a ready zone and/or an outstanding zone. In some examples, one or more EV threshold indicators (e.g., 302-324) have differing upper and/or lower limits, such as Credibility and Findability having an upper limit of “ready” rather than “outstanding. Each of the threshold zones is indicative of an EV magnitude required to maintain a degree of market success. Each EV magnitude may be represented as a percentage, a normalized value between zero and one, and/or any other type of scale indicative of EV magnitude. For example, if a product of interest rank versus the experience database 104 is between 30% and 80% for attention catching, then the EV threshold indicator 304 displays a “ready” zone 326 for the product of interest. As described above, other factors may have alternate zone ranges.

In other examples, if criteria product of interest rank versus the experience database 104 is between 80% and 100% for attention catching, then the EV threshold indicator 304 displays an “outstanding” zone 328 for the product of interest. In still other examples, if a product of interest rank versus experience database 104 is between 20% and 30% for attention catching, then the EV threshold indicator 304 displays a “risky” zone 330. Further, if criteria product of interest rank versus the experience database 104 is between 0% and 20% for attention catching, then the EV threshold indicator 304 displays a “failure” zone 332 for the product of interest. In the examples above and/or otherwise disclosed herein, each database rank is indicative of a probability, in which one or more probability ranges are grouped (bucketed) for interpretation.

While the illustrated example chart 300 of FIG. 3 includes twelve example EVs, any other number and/or combination of EVs (e.g., greater, fewer, equal) may be employed with example systems, apparatus, methods and/or articles of manufacture disclosed herein. Threshold values for each example EV may depend on and/or otherwise be indicative of (a) one or more survey responses by respondents in view of a product and/or product type, (b) actual in-market performance of the product and/or product type when compared to one or more success criteria, in which model threshold value(s) may indicate subsequent market performance and/or (c) a number of empirical observations of product market performance within the one or more success criteria having the same or similar survey responses by the respondents. In other words, the more frequently one or more EVs are deemed present within a product (or a concept of the product) and a subsequent success criteria is met, then the more certain the threshold is held as a reliable constant.

Generally speaking, as additional products and/or corresponding concepts associated with the product are analyzed by the example system 100, the example experience database 104 receives additional data/information related to how well and/or poorly one or more EVs affects subsequent market performance. As a result, a new product that has not yet been introduced into the market may be analyzed by the example system 100 to calculate a probability of success based on an increased assortment of empirical performance data, as described in further detail below. Additionally, in the event one or more EVs is initially believed to be a key factor in the success of a product in the marketplace, the example system 100 may predict whether the one or more EVs has the assumed effect. For example, while one EV may be believed to be a key factor of success at a first time (e.g., prior to the accumulation of empirical data, such as point of sale (POS) data, respondent data, merchant shopper card (e.g., preferred shoppers) data, etc.), the EV may be discarded at a second time if the market performance data indicates a loose and/or non-existent correlation to market performance.

Returning to the illustrated example of FIG. 1, the concept manager 112 integrates and/or otherwise receives information related to a new concept associated with a product of interest. As described in U.S. patent application Ser. No. 12/048,782, filed on Mar. 14, 2008, the entirety of which is hereby incorporated herein by reference, one or more survey questions may be directed to respondents to elicit information related to one or more EVs related to the product/concept. For example, to elicit respondent feedback related to the strength of the need/desire EV, the example survey manager 114 may present one or more questions, and one or more discrete answer choices, such as “agree strongly,” “agree somewhat,” “neither agree nor disagree,” “disagree somewhat,” and/or “disagree strongly.” Each candidate answer choice may include a corresponding weighted value that, in the aggregate, allows the EV to be coded to the product/concept of interest. The example explanatory variable correlation manager 108 of FIG. 1 may aggregate any number of respondent responses to establish and/or otherwise calculate a score for the EV. In some examples, the EV correlation manager 108 applies a mean function to the accumulated EV scores from each respondent to calculate an overall EV score associated with the product/concept of interest.

Survey results and calculated EV scores are stored in the example experience database 104 by the example concept manager 112. Additionally, the example concept manager 112 of FIG. 1 may store other metadata associated with the product/concept of interest, such as an associated category, an introductory target sale price, a geography in which the product is sold, an indication of marketing support, etc. A probability of market success for the new product/concept of interest is based on, in part, similar products and/or competitive products that have already experienced market performance. The example concept manager 112 of FIG. 1 identifies one or more similar product candidates to the new product/concept, and calculates a corresponding rank for the new product/concept. The rank may be based on, for example, corresponding scores for each available EV. In the illustrated example, analysis of the new product/concept based on a relative comparison to competitive products effectively equivalizes any difference that may exist due to category and/or country differences.

In the illustrated example, the threshold and probability calculator 110 examines the EV rank versus experience database 104 (e.g., scores) associated with the new product/concept and compares them to the one or more threshold values. In the event one or more of the EV scores is below one or more performance threshold values, the example market readiness manager 116 of FIG. 1 generates a warning. On the other hand, in the event one or more of the EV scores is above one or more performance threshold values, the example market readiness manager 116 of FIG. 1 generates an indication of potential success. Despite one or more warnings or success, or in the event none of the EV scores associated with the new product/concept fall above/below a threshold value, the example modeling engine 118 of FIG. 1 applies a model to the product/concept based on the EV scores and the relative rank of the product/concept versus the experience database 104 to generate an overall probability of success in the market based on all factors for success (e.g., the twelve factors of success disclosed above). The example modeling engine 118 may apply one or more models based on an ordinal outcome of one or more success metrics, such as application of an ordinal logistic regression. An ordinal logistic regression may overcome issues with standard regression models because the nature of the survey questions presents a variety of possible outcomes that are not binary. For example, respondents' responses include indications of “strongly agree,” “strongly disagree” and/or variations thereof, which ordinal regression can treat as factors for the application of linear regression that specifies link functions and/or scaling parameters. In some examples, the modeling engine 118 may apply ordinal nominal regression, or a polytomous universal model (PLUM), and/or apply one or more models based on a relationship between each EV and actual in-market success. In some examples, the modeling engine 118 may apply ordinal nominal regression, general linear regression, and/or other form(s) of regression models.

In the event the probability of success estimated by the example modeling engine 118 is satisfactory (e.g., satisfactory to the analyst, based on analyst observations of additional diagnostics, based on observations of initiative performance from research and/or historical observations of performance of products in same/similar categories, etc.), the example system 100 of FIG. 1 proceeds to one or more alternate products/concepts for analysis. On the other hand, in the event the probability of success estimated by the example modeling engine 118 is not satisfactory, the example simulation manager 120 of FIG. 1 adjusts one or more EVs to an alternate value to determine a new probability result. For example, the acceptable costs EV 320 of FIG. 3 may be in the risky zone with a database rank from the experience database 104 of approximately 29 (e.g., 29%). If an analyst believes that one or more pre-market launch changes to the product can be performed to bring the acceptable costs EV 320 to a database rank of approximately 34 (e.g., 34%), which is within a ready zone, then the example simulation manager 120 responds to an input indicating the same by invoking the example modeling engine 118 to estimate the model again to determine another probability of success value.

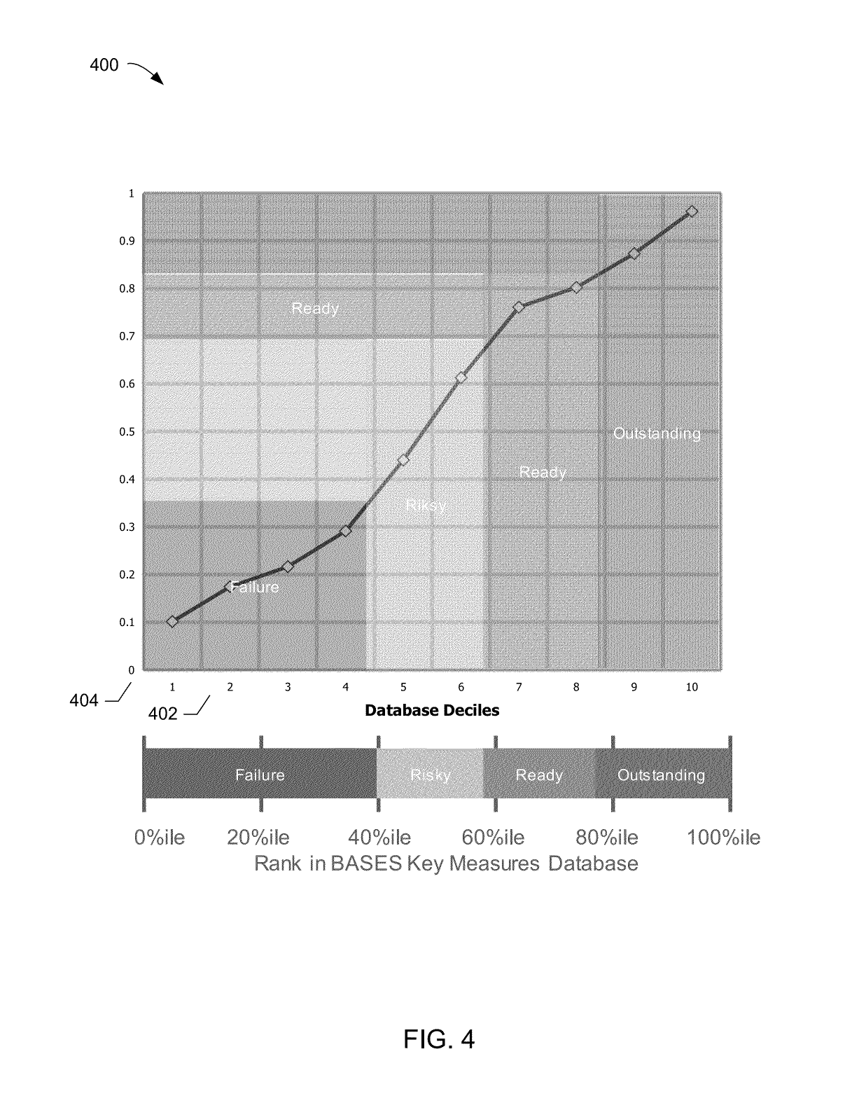

In other examples, the simulation manager 120 invokes the modeling engine 118 to build models for each EV in view of one or more definitions of success. Briefly turning to FIG. 4, an example product delivery EV (part of the endurance dimension) model 400 is built by the example modeling engine 118 and is representative of how product delivery maps to the survival of the commercial offering in the market. While the illustrated example of FIG. 4 includes a model 400 indicative of how product delivery aspects associated with a candidate commercial offering and/or a category in which the candidate commercial offering fits based on similarity, example methods, systems, apparatus and/or articles of manufacture disclosed herein are not limited thereto. For example, the modeling engine 118 may build any number of models for any EV, such as any or all of the twelve EVs described above. Additionally, each EV model generated and/or evaluated by the example modeling engine 118 may be built in view of a similar product type.

In the illustrated example of FIG. 4, the x-axis 402 represents a decile/rank of product delivery capability for the candidate commercial offering, in which the probability (y-axis 404) of two-year survival is modeled for each decile of the product delivery EV from the example experience database 104. For example, if the model 400 is designed for toilet bowl cleaning products and a previous survey for a candidate commercial offering related to toilet bowl cleaners met a measurable degree of expectations for product delivery (e.g., as determined by a mean of aggregated survey responses for the commercial offering), then the candidate commercial offering will fit within a relative rank along the x-axis decile. In other words, the decile represents a percentage of commercial offerings scoring greater than those previously tested. If the candidate commercial offering results in a 30% rank, then in the illustrated example, a corresponding probability of long term survival is 0.2. When compared to similar commercial offerings that have had marketplace exposure, such rank reveals that the candidate commercial offering of interest having the 30% rank is likely to fail to meet product delivery expectations and, thus, exhibit a relatively low probability of surviving in the market.

While the example model 400 of FIG. 4 is illustrated as a two dimensional graph, an example corresponding generalized equation may be represented in a manner consistent with example Equation 1.

$${p}_{x} = \frac{1}{1 + {e}^{( {EV}_{1} {xa}_{1} + {EV}_{2} {xa}_{2} + … + {FOS}_{1} + {FOS}_{2} + … )}} . \qquad Equation 1$$

In the illustrated example Equation 1, pₓ represents a probability response of the equation, EV₁ represents a first explanatory variable and a1 represents a corresponding coefficient, and FOS represents a particular factor of success magnitude. The example model may represent a profile of an initiative, which is based on unique results provided by respondents.

In the event that, for example, short term survival and long term survival form important aspects of an analyst marketing objective, then the example modeling engine 118 includes appropriately weighted principle component factors (response variables) related to product delivery, product loyalty, commitment, lack of rejection, the presence of adequate marketing support, concept initiative appeal, need/desire relevance, commitment, lack of barriers, acceptable costs, frequency metrics of a purchase cycle and whether trials were available. A two-step regression in view of long term survival and short term survival may occur in which each is modeled separately, and then brought together via a nested weakest link technique.

While an example manner of implementing a system 100 to assess marketing concepts prior to market participation has been illustrated in FIGS. 1-4, processes and/or devices illustrated in FIGS. 1-4 may be combined, divided, re-arranged, omitted, eliminated and/or implemented in any other way. Further, any or all of the example database interface 102, the example experience database 104, the example market performance manager 106, the example explanatory variable correlation manager 108, the example threshold and probability calculator 110, the example concept manager 112, the example survey manager 114, the example market readiness manager 116, the example modeling engine 118 and/or the example simulation manager 120 of FIG. 1 may be implemented by hardware, software, firmware and/or any combination of hardware, software and/or firmware. Thus, for example, any of the example database interface 102, the example experience database 104, the example market performance manager 106, the example explanatory variable correlation manager 108, the example threshold and probability calculator 110, the example concept manager 112, the example survey manager 114, the example market readiness manager 116, the example modeling engine 118 and/or the example simulation manager 120 of FIG. 1 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the apparatus or system claims of this patent are read to cover a purely software and/or firmware implementation, at least one of the example database interface 102, the example experience database 104, the example market performance manager 106, the example explanatory variable correlation manager 108, the example threshold and probability calculator 110, the example concept manager 112, the example survey manager 114, the example market readiness manager 116, the example modeling engine 118 and/or the example simulation manager 120 of FIG. 1 are hereby expressly defined to include a tangible computer readable storage medium such as a memory, DVD, CD, Blu-ray, etc. storing the software and/or firmware. Further still, the example system 100 of FIG. 1 may include one or more elements, processes and/or devices in addition to, or instead of, those illustrated in FIG. 1, and/or may include more than one of any or all of the illustrated elements, processes and devices.

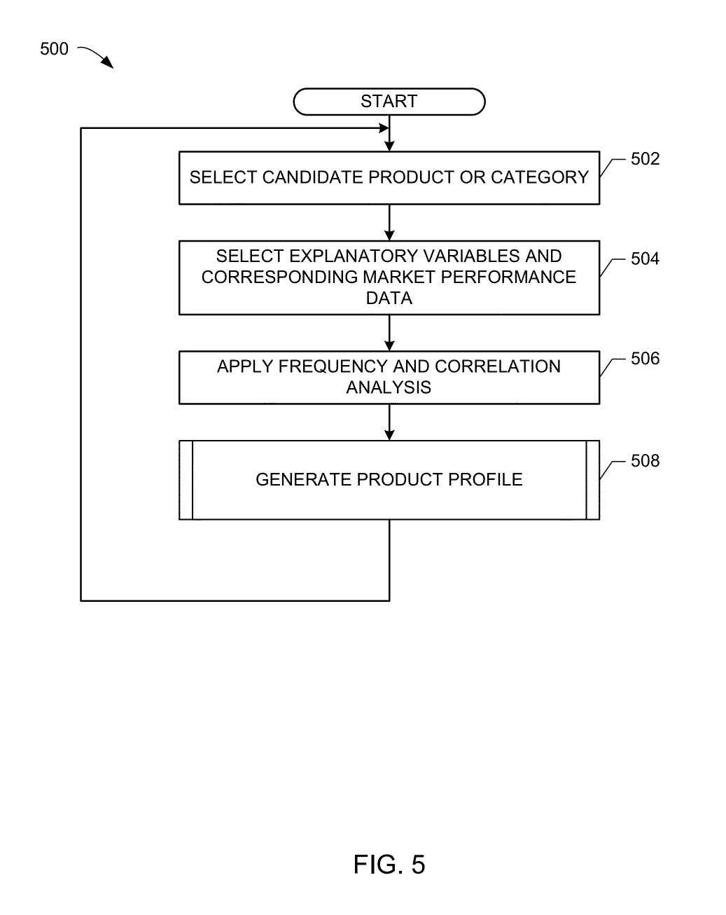

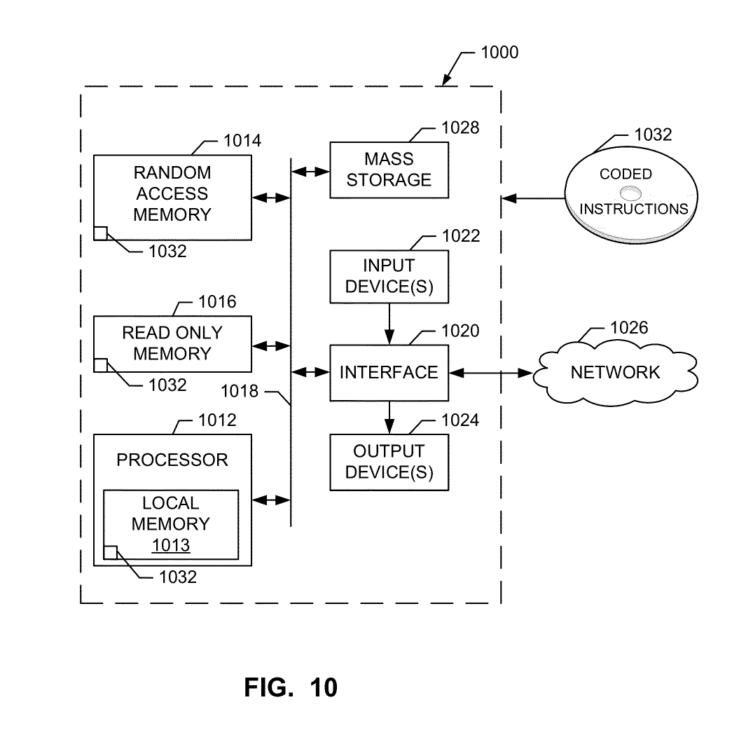

Flowcharts representative of example machine readable instructions for implementing the system 100 of FIGS. 1-4 are shown in FIGS. 5-9. In this example, the machine readable instructions comprise a program for execution by a processor such as the processor 1012 shown in the example computer 1000 discussed below in connection with FIG. 10. The program may be embodied in software stored on a tangible computer readable storage medium such as a CD-ROM, a floppy disk, a hard drive, a digital versatile disk (DVD), a Blu-ray disk, or a memory associated with the processor 1012, but the entire program and/or parts thereof could alternatively be executed by a device other than the processor 1012 and/or embodied in firmware or dedicated hardware. Further, although the example program is described with reference to the flowcharts illustrated in FIGS. 5-9, many other methods of implementing the example system 100 to assess marketing concepts prior to market participation may alternatively be used. For example, the order of execution of the blocks may be changed, and/or some of the blocks described may be changed, eliminated, or combined.

As mentioned above, the example processes of FIGS. 5-9 may be implemented using coded instructions (e.g., computer readable instructions) stored on a tangible computer readable medium such as a hard disk drive, a flash memory, a read-only memory (ROM), a compact disk (CD), a digital versatile disk (DVD), a cache, a random-access memory (RAM) and/or any other storage media in which information is stored for any duration (e.g., for extended time periods, permanently, brief instances, for temporarily buffering, and/or for caching of the information). As used herein, the term tangible computer readable storage medium is expressly defined to include any type of computer readable storage and to exclude propagating signals. Additionally or alternatively, the example processes of FIGS. 5-9 may be implemented using coded instructions (e.g., computer readable instructions) stored on a non-transitory computer readable storage medium such as a hard disk drive, a flash memory, a read-only memory, a compact disk, a digital versatile disk, a cache, a random-access memory and/or any other storage media in which information is stored for any duration (e.g., for extended time periods, permanently, brief instances, for temporarily buffering, and/or for caching of the information). As used herein, the term non-transitory computer readable medium is expressly defined to include any type of computer readable storage and to exclude propagating signals. As used herein, when the phrase “at least” is used as the transition term in a preamble of a claim, it is open-ended in the same manner as the term “comprising” is open ended. Thus, a claim using “at least” as the transition term in its preamble may include elements in addition to those expressly recited in the claim.

The program 500 of FIG. 5 begins at block 502 where the example database interface 102 selects a candidate commercial offering from the example experience database 104. The candidate commercial offering may include a product or service that is or was participating in a market (e.g., a particular geographic market) having associated stimuli. Example stimuli associated with a product and/or service may include, but is not limited to pictures, text, shape, color, title splash information, product description information and/or product price-point information. Additionally, the example database interface 102 may retrieve metadata associated with the candidate commercial offering including, but not limited to, product/service category, distribution information and/or geographic sales area(s). The example market performance manager 106 selects one or more available explanatory variables (EVs) associated with the candidate commercial offering (block 504), such as information from one or more EVs cultivated during respondent survey activities. Additionally, the example market performance manager 106 retrieves, from the example experience database 104, market performance data associated with the candidate commercial offering (block 504).

The example EV correlation manager 108 applies frequency and correlation analysis techniques in view of the one or more EVs and the market performance data (block 506). As described above, the example EV correlation manager 108 considers issues related to multi-colinearity to facilitate improved model performance and to expose two or more EVs that may have particular relationships to each other. In some examples, a product or a product type is identified by the EV correlation manager 108 to have particular EV relationships, while other products and/or product types have alternate and/or otherwise unique EV relationships. For each candidate commercial offering under evaluation, the example market performance manager 106 generates a profile (block 508), which may include cross-tabbing to identify unique relationships between in-market success (e.g., in-market performance metrics, such as volume, share, etc.) and the one or more EVs. Additionally, the example profile(s) generated by the market performance manager 106 (block 508) may include a chart to illustrate relative correlation values between all available EVs, such as the example EV correlation chart 200 of FIG. 2.

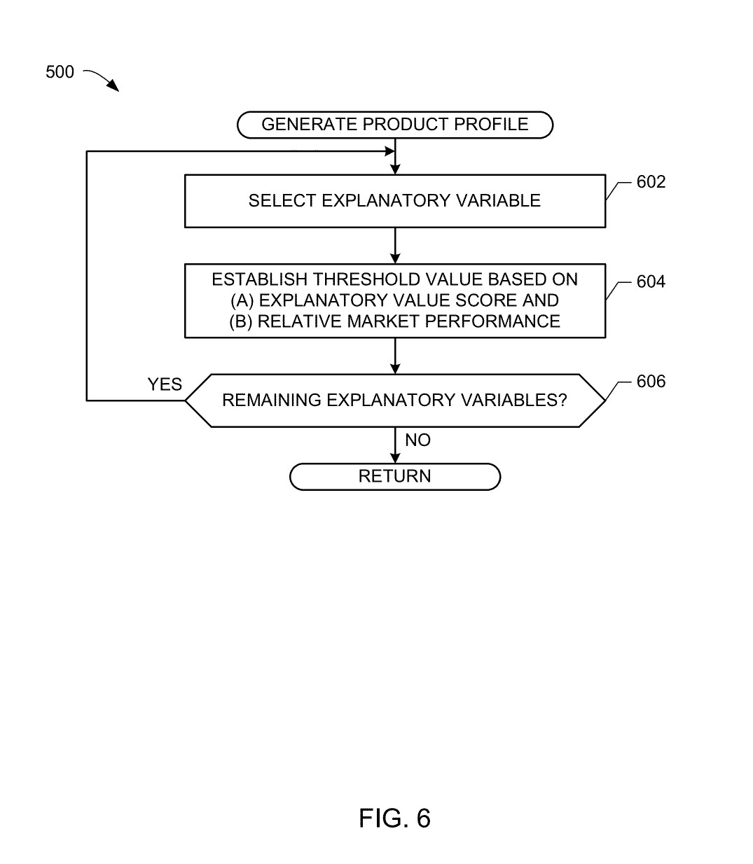

The program 508 of FIG. 6 begins at block 602 where the example market performance manager 106 selects one available EV associated with the commercial offering (e.g., a product and/or service having an associated concept). The example threshold and probability calculator 110 calculates a threshold value for the selected EV associated with the commercial offering that is based on an aggregated EV value (e.g., from respondent survey results) and a corresponding predicted market performance of the market offering on the given EV (block 604). In the event additional EVs are available for the commercial offering (block 606), control returns to block 602 where the example market performance manager 106 selects another available EV. As shown in the illustrated example of FIG. 3, some or all of the available EVs of the EV threshold chart 300 may have corresponding threshold values to identify conditions/labels including, but not limited to “outstanding,” “ready,” “risky,” and/or “failure.” In some examples, client preferences may include additional, fewer, substitute and/or otherwise alternate conditions/labels. As additional commercial offerings of a similar category are added to the example experiencedatabase 104 having corresponding EV values based on respondent survey responses, one or more threshold values for each EV may be adjusted. For example, repeated occurrences of a particular product category success with similar EV values reinforces one or more weight values for a corresponding EV value.

Example methods, systems, apparatus and/or articles of manufacture associated with FIGS. 5 and 6 build and/or otherwise cultivate the example experiencedatabase 104 with commercial offerings, corresponding EV values aggregated from, for example, respondent survey data. As the cultivated experiencedatabase 104 grows with additional survey-based EV values derived from respondent answers, EV threshold values and multi-colinearity issues are better understood and gain confidence. As described below, example methods, systems, apparatus and/or articles of manufacture employ the cultivated information from the example experiencedatabase 104 to generate one or more probability of success values for new commercial offerings (e.g., new products/services having associated concepts) that have not yet participated in the market (e.g., a retail market). One or more probability of success values may be calculated based on other similar existing commercial offerings (e.g., competitive products), corresponding EV values of the existing commercial offerings, a relative ranking (e.g., market performance based ranking) of the new commercial offering as compared to the existing commercial offerings, and EV values associated with the new commercial offering.

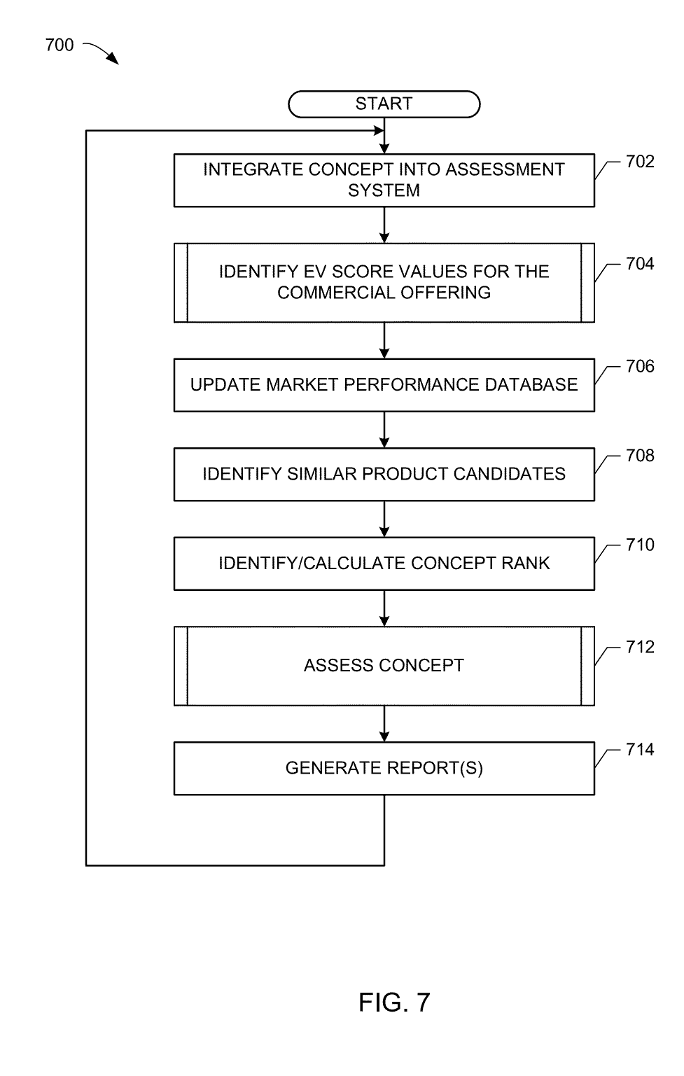

In the illustrated example program 700 of FIG. 7, the concept manager 112 integrates a new commercial offering and its corresponding concept details into the system 100 (block 702). As described above, a concept associated with a commercial offering (e.g., a product, a service, etc.) may include trade dress, product/service description, product size, product packaging, product/service feature claims, etc. The example survey manager 114 identifies EV score values for the new commercial offering (block 704), such as via one or more respondent survey exercises.

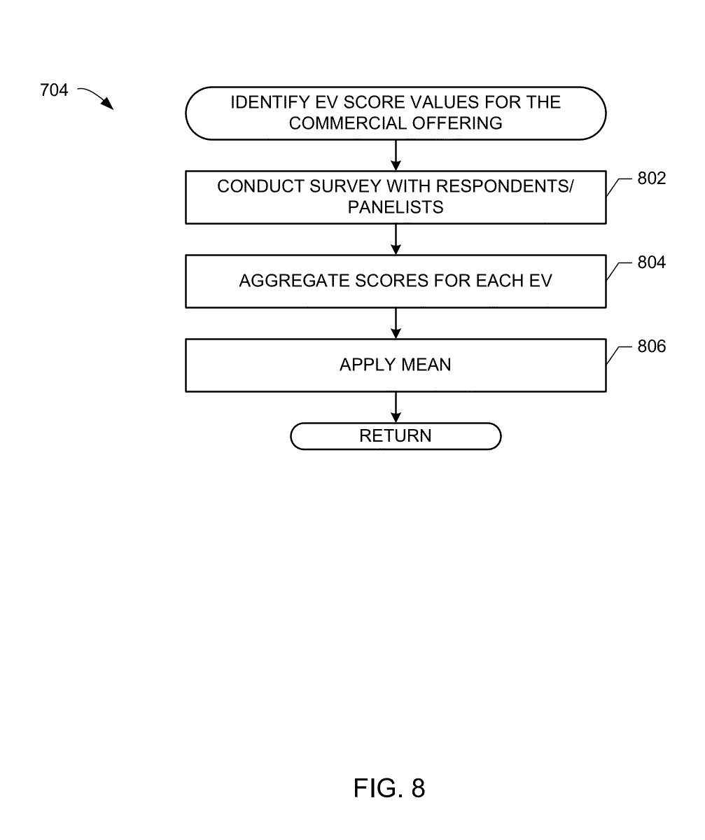

The program 704 of FIG. 8 begins at block 802 where the example survey manager 114 conducts one or more surveys with respondents. The example survey(s) presented to participants (e.g., panelists, non-panelists) may be tailored to elicit metric values related to the one or more EVs (e.g., product loyalty, acceptable costs, need/desire, etc.). For each commercial offering of interest, the example EV correlation manager 108 aggregates scores for each EV (block 804) and calculates a corresponding mean value (block 806).

Returning to the illustrated example of FIG. 7, the example concept manager 112 updates the experiencedatabase 104 with the concept information associated with the commercial offering, the EV score values and/or any other metadata associated with the commercial offering (block 706). The example concept manager 112 searches the example experiencedatabase 104 to identify one or more existing commercial offerings that are similar to the new commercial offering of interest (block 708). For example, if the new commercial offering is toilet bowl cleaner having particular concept details associated with a trade dress design, a title splash display, etc., then the concept manager 112 will extract one or more other toilet bowl products from the experiencedatabase 104. EV values and market performance data corresponding to the one or more similar commercial offerings are also obtained by the example concept manager 112 to rank the new commercial offering (block 710).

One or more success models, as described in further detail below, build upon relationships between new commercial offerings and one or more competitive products that are deemed most similar. Analysis in view of competitive and/or similar commercial offerings reduce errors typically associated with one or more attempts to interpret absolute scores for the new commercial offering(s). Additionally, absolute scoring techniques, unlike relative rank-based modeling, fail to add incremental value to model results. Further, modeling that is rank-based may equivalize any differences that could exist due to differing categories and/or geographies.

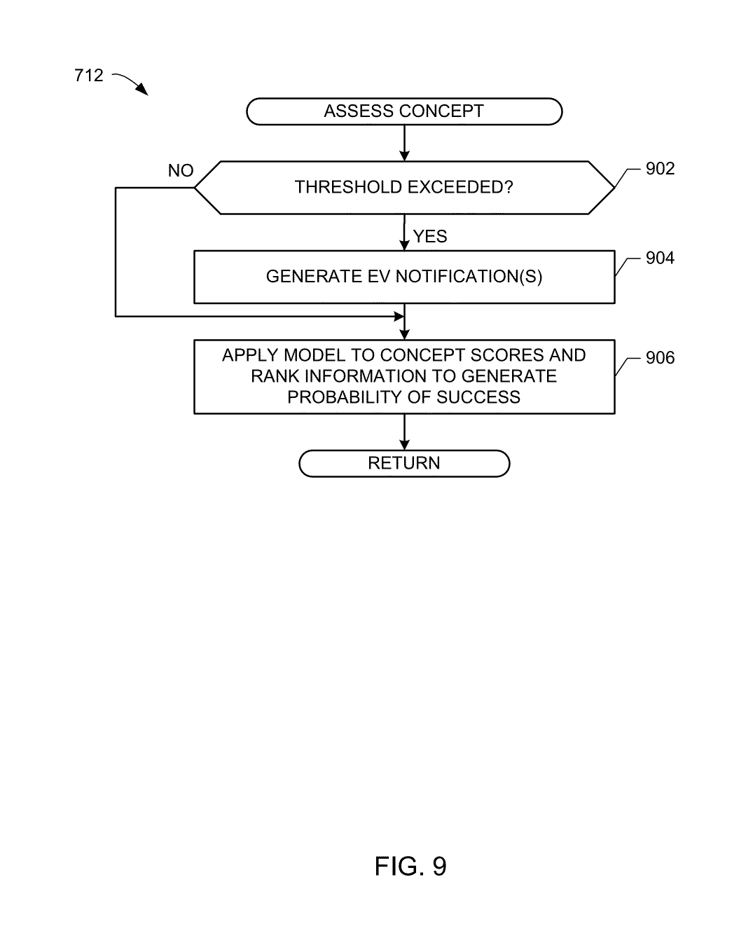

The example system 100 assesses the concept (block 712) in view of similar and/or competitive products, corresponding rank values, EV values associated with the new commercial offering, and EV value category thresholds. The program 712 of FIG. 9 begins at block 902 where the example threshold and probability calculator 110 determines whether the new commercial offering includes an instance of an associated EV value exceeding a threshold (e.g., threshold violations indicative of potential failure, threshold(s) indicative of potential success). In some examples, an aggregate score of EV values for a new commercial offering may be relatively high, but a single threshold violation (e.g., a “failure” zone) may result in poor market performance. In other words, the example threshold and probability calculator 110 identifies potential “weakest link” EVs that can cause market performance failure despite relatively strong values in other EVs for that commercial offering. Additionally, the example threshold and probability calculator 110 identifies potential successful EVs that can improve market performance. If the example threshold and probability calculator 110 identifies one or more instances where the threshold is exceeded (e.g., a violation) (block 902), then the example market readiness manager 116 generates one or more notifications (e.g., prompts, user interface (UI) graphics) and/or otherwise disseminates a potential cause for concern and/or rework of the candidate commercial offering or disseminates information indicative of potential success associated with the candidate commercial offering (block 904). On the other hand, if the example threshold and probability calculator 110 identifies one or more Whether a notification (e.g., a warning) is generated (block 904) or no EV value thresholds are exceeded (block 902), the example modeling engine 118 applies a model (e.g., an ordinal logistic regression model, a polytomous universal model, etc.) to the commercial offering based on its EV scores and its relative rank to generate a probability of success in the market (block 906). Returning to FIG. 7, the example system 100 may generate one or more reports based on the modeled probability (block 714).

FIG. 10 is a block diagram of an example processor platform 1000 capable of executing the instructions of FIGS. 5-9 to implement the system 100 of FIG. 1. The processor platform 1000 can be, for example, a server, a personal computer, an Internet appliance, or any other type of computing device.

The system 1000 of the instant example includes a processor 1012. For example, the processor 1012 can be implemented by one or more microprocessors or controllers from any desired family or manufacturer.

The processor 1012 includes a local memory 1013 (e.g., a cache) and is in communication with a main memory including a volatile memory 1014 and a non-volatile memory 1016 via a bus 1018. The volatile memory 1014 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1016 may be implemented by flash memory and/or any other desired type of memory device. Access to the main memory 1014, 1016 is controlled by a memory controller.

The processor platform 1000 also includes an interface circuit 1020. The interface circuit 1020 may be implemented by any type of interface standard, such as an Ethernet interface, a universal serial bus (USB), and/or a PCI express interface.

One or more input devices 1022 are connected to the interface circuit 1020. The input device(s) 1022 permit a user to enter data and commands into the processor 1012. The input device(s) can be implemented by, for example, a keyboard, a mouse, a touchscreen, a track-pad, a trackball, isopoint and/or a voice recognition system.

One or more output devices 1024 are also connected to the interface circuit 1020. The output devices 1024 can be implemented, for example, by display devices (e.g., a liquid crystal display, a cathode ray tube display (CRT), a printer and/or speakers). The interface circuit 1020, thus, typically includes a graphics driver card.

The interface circuit 1020 also includes a communication device such as a modem or network interface card to facilitate exchange of data with external computers via a network 1026 (e.g., an Ethernet connection, a digital subscriber line (DSL), a telephone line, coaxial cable, a cellular telephone system, etc.).

The processor platform 1000 also includes one or more mass storage devices 1028 for storing software and data. Examples of such mass storage devices 1028 include floppy disk drives, hard drive disks, compact disk drives and digital versatile disk (DVD) drives.

The coded instructions 1032 of FIGS. 5-9 may be stored in the mass storage device 1028, in the volatile memory 1014, in the non-volatile memory 1016, and/or on a removable storage medium such as a CD or DVD.

Methods, apparatus, systems and articles of manufacture to assess marketing concepts prior to market participation facilitate one or more probability of success calculations for new commercial offerings that have not yet had market exposure. In some examples, the system 100 allows an analyst to delay market introduction of the candidate commercial offering in the event a corresponding probability is low. Example probability calculations performed by methods, apparatus, systems and/or articles of manufacture disclosed herein also incorporate relative comparisons between the candidate new commercial offering and factors associated with similar products, such as competitive product explanatory variable rank(s) and past market performance.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method to generate a probability of success for a new commercial offering, comprising:
determining, with a processor, a value for an explanatory variable (EV) associated with the new commercial offering;
identifying a plurality of existing commercial offerings based on a similarity metric associated with the new commercial offering;
identifying a rank of the new commercial offering based on a comparison between the EV value associated with the new commercial offering and EV values associated with the plurality of existing commercial offerings; and
generating, with the processor, the probability of success for the new commercial offering based on the rank of the new commercial offering and in-market performance metrics associated with the plurality of existing commercial offerings.

2. A method as defined in claim 1, further comprising determining correlation scores between the EV values associated with the plurality of existing commercial offerings.

3. A method as defined in claim 2, further comprising stabilizing a model to generate the probability of success in response to detecting multi-colinearity between at least two of the EV values associated with the plurality of existing commercial offerings.

4. A method as defined in claim 1, further comprising identifying threshold values for respective EVs associated with the plurality of existing commercial offerings.

5. A method as defined in claim 4, wherein the threshold value are respectively based on a success response variable and a range of EV values associated with the EV.

6. A method as defined in claim 5, wherein the range of EV values is proportional to the in-market performance metrics.

7. A method as defined in claim 4, further comprising generating an alarm notification when one of the EV values associated with the new commercial offering falls below the threshold value for at least one EV associated with the plurality of existing commercial offerings.

8. A method as defined in claim 4, further comprising generating a notification indicative of success when one of the EV values associated with the new commercial offering exceeds the threshold value for at least one EV associated with the plurality of existing commercial offerings.

9. A method as defined in claim 1, wherein generating the probability of success comprises a regression function.

10. A method as defined in claim 1, wherein the new commercial offering comprises a commercial offering that has not been involved with prior market exposure.

11. A method as defined in claim 1, wherein the new commercial offering comprises a revised commercial offering.

12. A method as defined in claim 1, wherein the existing commercial offering comprises at least one of a conceptual commercial offering or a commercial offering that has not been launched.

13. A method as defined in claim 12, wherein the existing commercial offering has been previously tested.

14. An apparatus to generate a probability of success for a new commercial offering, comprising:
a survey manager to determine a value for an explanatory variable (EV) associated with the new commercial offering;
a concept manager to identify a plurality of existing commercial offerings based on a similarity metric associated with the new commercial offering, and to identify a rank of the new commercial offering based on a comparison between the EV value associated with the new commercial offering and EV values associated with the plurality of existing commercial offerings; and
a threshold and probability calculator to generate the probability of success for the new commercial offering based on the rank of the new commercial offering and in-market performance metrics associated with the plurality of existing commercial offerings.

15. An apparatus as defined in claim 14, further comprising a variable correlation manager to determine correlation scores between the EV values associated with the plurality of existing commercial offerings.

16. An apparatus as defined in claim 15, further comprising a modeling engine to stabilize a model to generate the probability of success in response to detecting multi-colinearity between at least two of the EV values associated with the plurality of existing commercial offerings.

17. An apparatus as defined in claim 14, wherein the threshold and probability calculator is to identify threshold values for respective EVs associated with the plurality of existing commercial offerings.

18. An apparatus as defined in claim 17, wherein the threshold values are based on a success response variable and a range of EV values associated with the EV.

19. An apparatus as defined in claim 17, further comprising a market readiness manager to generate an alarm notification when one of the EV values associated with the new commercial offering falls below the threshold value for at least one EV associated with the plurality of existing commercial offerings.

20. An apparatus as defined in claim 17, further comprising a market readiness manager to generate a notification indicative of success when one of the EV values associated with the new commercial offering exceeds the threshold value for at least one EV associated with the plurality of existing commercial offerings.

21. A tangible machine readable storage medium comprising instructions that, when executed, cause a machine to, at least:
determine, with a processor, a value for an explanatory variable (EV) associated with a new commercial offering;
identify a plurality of existing commercial offerings based on a similarity metric associated with the new commercial offering;
identify a rank of the new commercial offering based on a comparison between the EV value associated with the new commercial offering and EV values associated with the plurality of existing commercial offerings; and
generate, with the processor, the probability of success for the new commercial offering based on the rank of the new commercial offering and in-market performance metrics associated with the plurality of existing commercial offerings.

22. A machine readable storage medium as defined in claim 21, wherein the machine readable instructions, when executed, cause the machine to determine correlation scores between the EV values associated with the plurality of existing commercial offerings.

23. A machine readable storage medium as defined in claim 22, wherein the machine readable instructions, when executed, cause the machine to stabilize a model to generate the probability of success in response to detecting multi-colinearity between at least two of the EV values associated with the plurality of existing commercial offerings.

24. A machine readable storage medium as defined in claim 21, wherein the machine readable instructions, when executed, cause the machine to identify threshold values for respective EVs associated with the plurality of existing commercial offerings.

25. A machine readable storage medium as defined in claim 24, wherein the machine readable instructions, when executed, cause the machine to generate an alarm notification when one of the EV values associated with the new commercial offering falls below the threshold value for at least one EV associated with the plurality of existing commercial offerings.

26. A machine readable storage medium as defined in claim 24, wherein the machine readable instructions, when executed, cause the machine to generate a notification indicative of success when one of the EV values associated with the new communication offering exceeds the threshold value for at least one EV associated with the plurality of existing commercial offerings.
